(19) United States
(12) Patent Application Publication
(10) Pub. No.: US 2013/0325731 A1
(43) Pub. Date: Dec. 5, 2013

(54) SYSTEMS AND METHODS FOR PROVIDING ORGANIZATIONAL COMPLIANCE MONITORING

(71) Applicants: N. Michelle Guarnery, San Antonio, TX (US); Michael Foley, San Antonio, TX (US); Stephanie Higby, Helotes, TX (US); Kellie Weber, Spring Branch, TX (US)

(72) Inventors: N. Michelle Guarnery, San Antonio, TX (US); Michael Foley, San Antonio, TX (US); Stephanie Higby, Helotes, TX (US); Kellie Weber, Spring Branch, TX (US)

(73) Assignee: UNITED SERVICES AUTOMOBILE ASSOCIATION (USAA), San Antonio, TX (US)

(21) Appl. No.: 13/871,663

(22) Filed: Apr. 26, 2013

Related U.S. Application Data
(60) Provisional application No. 61/639,036, filed on Apr. 26, 2012.

(51) Int. Cl. G06Q 30/00

(52) U.S. Cl. CPC G06Q 30/018
USPC 705/317

(57) ABSTRACT

A method performed by a computing device and having one or more processors and memory storing one or more programs for execution by the one or more processors, comprising information including a representation of at least one compliance issue is received. The information is analyzed to determine at least one entity to which the at least one compliance issue is pertinent. The information is forwarded to the at least one entity in response to a determination that the legal change is pertinent to the at least one entity. A response is received from the at least one entity a response including a representation as to how the at least one entity intends to address the compliance issue.

### RELATED APPLICATION

The present application claims the benefit of co-pending U.S. Provisional Patent Application No. 61/639,036, filed Apr. 26, 2012, the entire contents of which is incorporated herein by reference.

### BACKGROUND OF THE INVENTION

The proliferation of changes to laws, regulations, and enforcement thereof poses a huge challenge for businesses and other organizations. Because these changes occur at the international, national, state, and municipal level, at any given time, there may be hundreds if not thousands of changes to existing laws and regulations taking effect. Some legal changes occur as the result of new laws and regulations and some are the result of amendments or changes in the enforcement of existing laws and regulations. The sheer volume of legal changes can make it extremely difficult for affected organizations to comply and maintain compliance with laws and regulations.

Many organizations process legal change in an ad hoc manner. Individuals within the organization are tasked with monitoring statutes and registers and notifying relevant stake holders of any changes in laws or regulations that are of concern to them. The stake holders are then be responsible for ongoing compliance with the law.

While such an approach can be effective, it suffers from certain drawbacks. First, for organizations with many organizational units, it is difficult for compliance officers to understand, at any given time, the level at which the entire organization is in compliance. For instance, one part of the organization may be in compliance while another part is not. Compliance officers may repeatedly poll the various organizations, but the time lag involved will leave them without an accurate snapshot of the compliance status of the entire organization.

Second, the ad hoc approach is only works as well as the information provided. For instance, if controls are not robust enough or if they are not maintained, then the organization may not be in compliance. Yet, due to the nature of interpersonal communication, it may be difficult for a compliance office to get accurate information regarding the specific controls that are in place and the level to which they are being followed.

Third, a compliance officer may recognize that some legal compliance issues pose more risk than others. Therefore, higher risk issues may need to be monitored more frequently. However, this is difficult to do without a methodology for categorizing risk and monitoring higher risk issues more frequently than others.

### SUMMARY

In view of the aforesaid, what is needed are systems and methods for providing organizational compliance monitoring. Accordingly, described herein are methods and systems that provide organizations (e.g. business, governmental, charitable, not for profit, etc.) with the ability to monitor workflow and controls associated with legal compliance. Such methods and systems include the ability to: receive notice of legal changes; efficiently direct such notices to those organizations, individuals, business units, or other entities to whom the legal changes are of concern; receive a plan outlining a plan with controls by which the affected organization, individual, or business unit shall comply with the legal change; and to provide verification that the plan has been put in effect. Also described are methods and systems for forward monitoring of compliance and ranking of organizational risks associated with compliance. It should be noted that the summary provided herein is for the general benefit of the reader and should not be construed as limiting or interpreting the scope of claims provided herein.

### BRIEF DESCRIPTION OF THE DRAWINGS

So that those having ordinary skill in the art, to which the present invention pertains, will more readily understand how to employ the novel system and methods of the present invention, certain illustrated embodiments thereof will be described in detail herein-below with reference to the drawings, wherein:

FIG. 1 depicts an organizational compliance system;

FIG. 2 depicts one embodiment of a compliance device utilized in the organizational compliance system, or FIG. 1.

FIG. 3 depicts a heat map that can be utilized in the system of FIG. 1.

FIG. 4 depicts an illustrative embodiment of operation of the system of FIG. 1.

A component or a feature that is common to more than one drawing is indicated with the same reference number in each of the drawings.

### DETAILED DESCRIPTION OF CERTAIN EMBODIMENTS

The present disclosure is directed to an organizational compliance system and methods for operating the same. It is to be appreciated the subject invention is described below more fully with reference to the accompanying drawings, in which illustrated embodiments of the present invention are shown. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated that certain embodiments of this invention as discussed below are a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

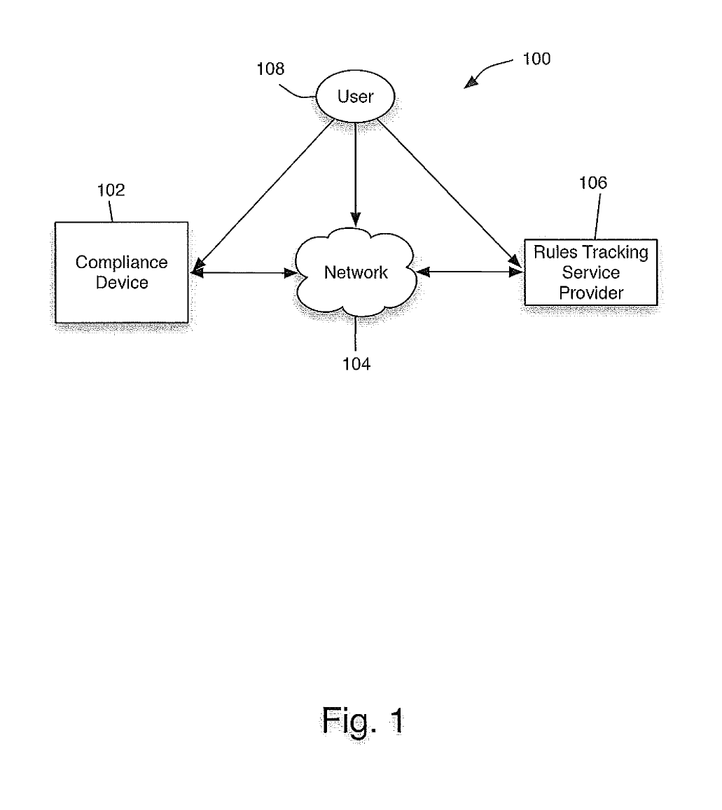

Referring to FIG. 1, a system 100 in which the processes described herein can be executed is provided for exemplary purposes. In one example, system 100 includes one or more compliance devices 102, a network 104, and at least one rules tracking service provider 106.

In one example, a compliance device 102 may comprise a computing device. Computing devices include but are not limited to general purpose computers, servers, mobile devices (e.g. smart phones, tablets, etc.), and notebooks. It should be understood that computing devices generally include at least one processor, at least one data interface, and at least one memory device coupled via buses. A computing device may include one or more hardware and/or software components that contain instructions for execution by the at least one processor. Such instructions may be written in a computer programming language to execute the processes and functions described herein. An example of such instructions includes a compliance, risk, or governance program. For example, BWise® is a corporation that offers such a program.

It should be noted that computing devices may be capable of being coupled together, coupled to peripheral devices, and input/output devices. Compliance device 102 is represented in the drawings as a standalone device but should not be limited to such. The functions described herein could be performed by a single compliance device 102 or spread across multiple computing devices in a distributed processing environment. Compliance device 102 may communicate with other compliance devices 102 and other devices within an organization over network 104. Compliance device 102 also communicates with legal tracking service provider 106 over network 104. In addition, compliance device 102 may include one or more databases that store data regarding an organization, business unit, individual, or other entity's compliance with applicable laws and regulation. In another embodiment, such data may reside elsewhere on network 104 and be communicated to compliance device as needed.

Compliance device 102 in one example is operated by at least one user 108. In one example, a user 108 is an individual or entity that is responsible for responding or addressing a compliance issue. A compliance issue in one example is an issue that requires some action or response to insure that an organization, business unit, individual, or other entity (hereinafter referred to individually as an “entity” and collectively as “entities”) is engaging in behavior consistent with a rule.

A rule in one example is a law, a statute, a regulation, an administrative decision, a court decision, etc. or proposals for the same. For instance, a law or regulation may be likely to take effect and therefore an organization may elect to begin compliance in anticipation of the law taking effect. A compliance issue may arise due to a change in existing law, a change in enforcement of an existing law, a proposed change to an existing law, a proposed new law, a new law, or the identification that compliance is lacking with respect to a law. It should be noted that the term rule should not be limited to something that is promulgated by a government, legislative, or judicial body. For instance, an entity may want to comply with the regulations of standards body or a supranational authority. A rule may also be an internal policy.

A user 108 in one example responsible, in whole or in part, for insuring that an entity is in compliance with law or regulation or for insuring that an entity will be in compliance with a future law or regulation or for insuring that an entity will be in compliance with a change to an existing law or regulation. An example of such a user 108 is a compliance officer of organization, such as a bank, an investment firm, an insurance company, a real estate firm, or any entity that is expected to comply with a laws or regulation. Another example of user 108 is an entity who is responsible for complying with a rule. For instance, some entities have compliance officers who are responsible for monitoring and insuring that the entity is in compliance with rules, but there are other entities who are responsible for engaging in the actual practices that comply with the rules.

It should be noted that there are multiple ways for users 108 and entities to address a compliance issue. For instance, an entity may elect to do nothing. An entity may elect to wait and revisit the compliance issue at a later time. The entity may elect to create a compliance plan. A compliance plan in one example includes a set of steps, actions, processes, decisions, and the like (hereinafter referred to as “controls”) for complying and maintaining compliance with a rule. Regardless of the how the entity elects to resolve a compliance issue in order to understand an entities compliance state, system 100 creates a workflow when a compliance issues arises. Such a workflow may result in a compliance plan, action being deferred, or in no action.

Referring further to FIG. 1, it should be noted that user 108 does not have to be a human being. For instance, user 108 could be a virtual user that is programmed to perform certain business can compliance processes. In another example, user 108 may be a hardware and/or software process operating on compliance device 102 or elsewhere on network 104.

Referring further to FIG. 1, it is to be appreciated that network 104 depicted in FIG. 1 may include a local area network (LAN) and/or a wide area network (WAN), but may also include other networks such as a personal area network (PAN). Such networking environments are commonplace in offices, enterprise-wide computer networks, intranets, and the Internet. For instance, when used in a LAN networking environment, the system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the system 100, or portions thereof, may be stored in a remote memory storage device such as storage medium. Compliance devices 102 and legal tracking service provider 106 communicate over network 104 through one or more communications links formed between data interfaces of compliance devices 102 and tracking service provider 106, respectively. Communication links may comprise either wired or wireless links. It is to be appreciated that the illustrated network connections of FIG. 1 are exemplary and other means of establishing a communications link between multiple devices may be used. It is also to be appreciated that a myriad of other devices that are not shown may also be connected to compliance devices 102 and legal tracking service provider 106. It should be understood that the these devices may perform a number of functions that are well known in enterprise wide computing environments, such as data storage, data entry, and data manipulation.

Rules tracking service provider 106 in one example is a service that provides information regarding rules. Such information may include, but is not limited to, the state of current laws (or regulations), amendments to current laws (or regulations), proposed amendments to current laws (or regulations), proposed new laws (or regulations), or changes in enforcement of current laws (or regulations), judicial decisions, administrative decisions, and the like. The information may include legal text, such as the complete text of the law or regulation and/or commentary regarding the law or regulation. The information may include a field identifying one or more entities to whom rule is relevant or pertinent. An example of a rules tracking service provider 106 is StateScape, a company located in Alexandria, Va.

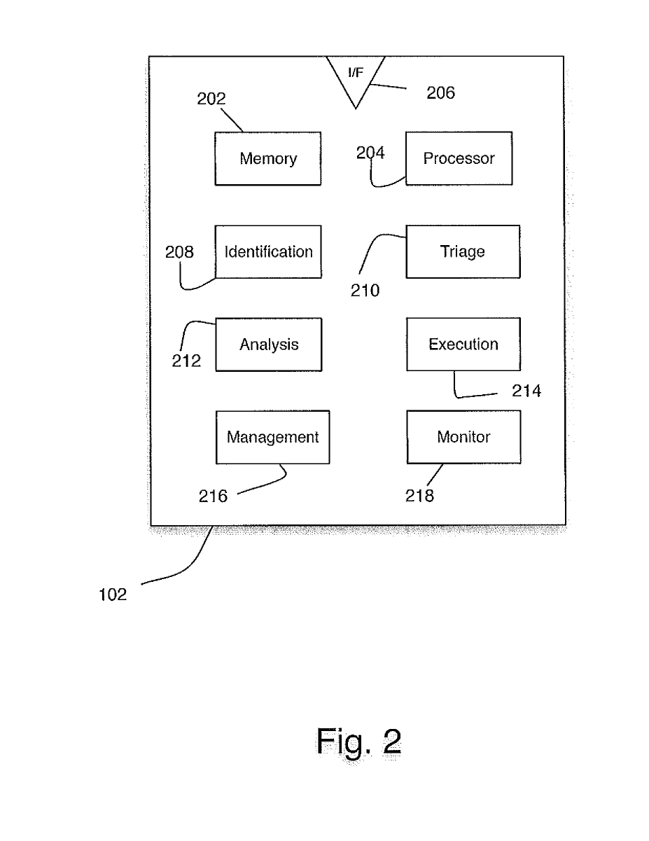

Referring to FIG. 2, compliance device 102 in one embodiment includes a memory device 202, a processor 204, a data interface 206, an identification engine 208, a triage engine (TE) 210, an analysis engine 212, an execution engine 214, a management engine 216, and, and monitoring engine 218.

Memory device 202 in one example comprises a computer-readable signal-bearing medium. One example of a computer-readable signal-bearing medium comprises a recordable data storage medium, such as a magnetic, optical, biological, and/or atomic data storage medium. In another example, a computer-readable signal-bearing medium comprises a modulated carrier signal transmitted over a network coupled with system 100, for instance, a telephone network, a local area network (“LAN”), the Internet, and/or a wireless network. In one example, memory device 202 includes a series of computer instructions written in or implemented with any of a number of programming languages, as will be appreciated by those skilled in the art.

Memory device 202 in one example holds information. Such information may relate to an entity's compliance with rules. For instance, information may include business records detailing the impact of a rule on an entity, and a record indicating that a compliance officer has approved the plan as complying with the law or regulation. The information may also include a risk analysis ranking the impact that not complying with a law or regulation would have on the organization and/or the strength of the plan or control in providing compliance. Such a record would provide an organization the means to monitor ongoing compliance and to determine whether compliance controls should be strengthened.

Processor 204 is an electronic device configured of logic circuitry that responds to and executes instructions. Processor 204 may comprise more than one distinct processing devices, for example to handle different functions within compliance device 102. Processor 204 may output results of an execution of the methods described herein to an output device connected to interface 206. Alternatively, processor 204 could direct the output to another device via network 104.

At least one data interface 206 may include the mechanical, electrical, and signaling circuitry for communicating data over network 104. Interface 206 may be configured to transmit and/or receive data using a variety of different communication protocols and various network connections, e.g., wireless and wired/physical connections. Interface 206 may include an input device, such as a keyboard, a touch screen or a speech recognition subsystem, which enables a user to communicate information and command selections to processor 204. Interface 206 may also include an output device such as a display screen, a speaker, a printer, etc. Interface 206 may include an input device such as a touch screen, a mouse, track-ball, or joy stick, which allows the user to manipulate the display for communicating additional information and command selections to processor 204.

The term “engine” with reference to identification engine 208, triage engine 210, analysis engine 212, execution engine 214, management engine 216, and monitoring engine 218 denotes a functional operation that may be embodied either as a stand-alone component or as an integrated configuration of a plurality of subordinate components. Thus, identification engine 208, triage engine 210, analysis engine 212, execution engine 214, management engine 216, and monitoring engine 218 may be implemented as a single module or as a plurality of modules that operate in cooperation with one another. Moreover, identification engine 208, triage engine 210, analysis engine 212, execution engine 214, management engine 216, and monitoring engine 218 may be implemented as software instructions in memory 202 or separately in any of hardware (e.g., electronic circuitry), firmware, software, or a combination thereof. In one embodiment, identification engine 208, triage engine 210, analysis engine 212, execution engine 214, management engine 216, and monitoring engine 218 contain instructions for controlling processor 204 to execute the methods described herein. Examples of these methods are explained in further detail in the subsequent of exemplary embodiments section-below.

Referring further to FIG. 2, identification engine 208 in one example is utilized by system 100 to identify a compliance issue. Such a compliance issue may be input by a user 108 or received over network 104. For example, a user 108 may determine that an entity is not in compliance with a rule and open a workflow to respond to the compliance issue. In another example, rules tracking service provider 106 may send information to compliance device 102 over network 104 indicating that there has been one or more rule changes. In another example, a user 108 may load a file into compliance device 102 that is received from rules tracking service provider 106 indicating that one or more rules changes have occurred. In a further example, a user 108 may manually enter one or more rules changes.

A compliance issue may also be a request by a user 108 to monitor the current compliance of an entity with a rule. For instance, there may be rule that if not followed, could expose the entity to high risk. Accordingly the user may 108 want to regularly monitor the entity for compliance. In another example, a particular control put in place to address a compliance issue may be perceived by the user 108 as weak. The user 108 may want to regularly monitor the control to determine if the control is effective. In another example, a user 108 may determine that event is about to occur that may result in a compliance issue (e.g. a business reorganization). Therefore, the user 108 may elect to monitor compliance after the event.

Referring further to FIG. 2, once identification engine 208 identifies a compliance issue, system 100 commences a workflow address the compliance issue. In order to address the compliance issue, the proper users 108 and entities must be notified of the compliance issue. For instance, if a new banking regulation is promulgated, there is no need to send it to a property and casualty organization. Therefore, triage engine 210 is utilized to analyze compliance issues and determine the correct entity or user 108 who should be notified of such compliance issue and be tasked with analyzing it. Triage engine 210 may also determine that no action is needed and close the workflow.

In one example, triage engine reviews the information provided to identification engine 208 that resulted in the workflow to identify terms or phrases that are pertinent to a particular entity. For instance, a large organization may include a an automobile insurance business, a banking business, a property and casualty business, and an investment business. Triage engine 210 may parse the text of the information to identify the particular unit or units to whom the information regarding the legal issue is relevant or pertinent. For instance, the text of a law may include the phrase “homeowner policy” and accordingly triage engine 210 may conclude that the law is pertinent to the property and casualty unit. In another example, rules tracking service provider 206 may populate the information with a field identifying a rule and specifying the entity to whom it is relevant. For instance, a data field may include a “B” to indicate that it is pertinent to a banking unit, a “PNC” to indicate that it pertinent to a property and casualty unit, an “A” to indicate that it pertinent to an automobile insurance unit.

It should also be noted that a compliance issue may be pertinent to more than one entity within an organization. Accordingly, triage engine 210 may identify multiple entities or sub-entities so whom the issue is pertinent or relevant. In one example, upon identification of the appropriate entity, triage engine 210 will send the information to analysis engine 212. In another example, triage engine 210 may provide a user interface through which a user 108 may review a compliance issue and determine the appropriate entity or entities to whom it is pertinent. Triage engine 210 will then send a notification to such entity or individuals representing such entities for analysis and execution through analysis engine 212 and execution engine 214.

Analysis engine 212 in one example utilizes business rules to help an entity determine the impact that a compliance issue may have on the entity and provide a plan, including one or more controls, to address the legal issue. For instance, analysis engine 212 may review and parse the text of a new law or regulation and determine that a particular regulatory filing must occur on a certain date every year and recommend that such a filing begin being prepared a certain time in advance. In another example, analysis engine 212 may determine that a new regulation requires a certain notice to be sent to a consumer on a regular basis and recommend that such a notice be immediately prepared for review by relevant stakeholders within an organization. Upon determining the impact, analysis engine 212 may populate memory 202 with a record detailing its plan of controls for addressing the compliance issue. In another example, analysis engine 212 may provide a user interface through which a user 108 in a pertinent entity may address and/or analyze a compliance issue. User 108 may then populate a record in memory 202 with a record detailing such analysis.

Referring to FIG. 2, execution engine 214 in one example executes the plan formulated by analysis engine 212. In one example, this involves preparing a project plan, including controls, and logging progress of plan execution. For instance, in the preceding example, analysis engine 212 may have determined that it was necessary to prepare a regulatory filing by a certain date. Accordingly, execution engine 214 may begin compiling data and preparing such a filing. Execution engine 214 would log in memory 202 the status of the preparation such that users 108 could access system 100 and determine the status of the workflow. In another example, execution engine 214 may provide a user interface for a user 108 representing a relevant entity to enter a project plan and/or progress regarding the response to a legal issues.

Referring further to FIG. 2, management engine 216 in one example provides management control over a compliance workflow. For instance, management engine 216 may determine that an entity is not in compliance with a law or regulation and request through identification engine 208 that a workflow commence to address the lack of compliance. In another example, management engine 216 may provide the interface through which a user 108, such as a compliance officer, may review a workflow and close the workflow because the user 108 has determined that the steps taken by the analysis engine 212 and execution engine 214 sufficiently addresses the compliance issue. In another example, management engine 216 may identify that a compliance issue requires no action and close a corresponding workflow. In another example, management engine 216 may provide a user interface that allows a user 108 to perform these actions.

Referring still to FIG. 2, monitoring engine 218 in one example provides functionality by which a compliance issue is monitored on an ongoing basis. For instance, it may be determined after a workflow is complete that ongoing monitoring is warranted to insure that an individual, business unit, organization and/or other entity remains in compliance with a law or regulation. Accordingly, monitoring engine 218 provides ongoing monitoring of the status of the control. In another example, monitoring engine 218 may alert a user 108 such that the user 108 can initiate a workflow or request the status of a particular control.

In another example, monitoring engine 218 may conduct a risk analysis to determine the impact of non-compliance with certain laws or regulations and to rank the strength of certain controls instituted to insure compliance thereto.

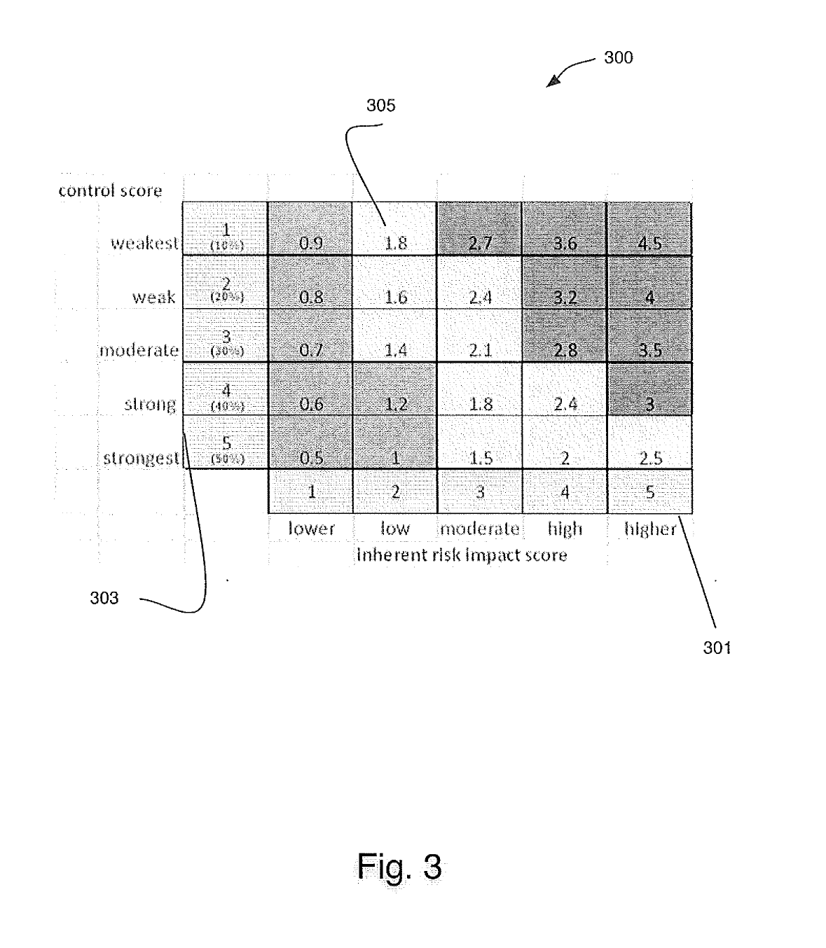

Referring to FIG. 3, an exemplary heat map 300 is depicted that creates a residual risk score related to a compliance issue. The x-axis 301 provides inherent risk impact score (IRIS). The IRIS in one example ranks the impact that a compliance issue has on an entity. For instance, if an organization does not comply with a law or regulation, the risk to the organization (e.g. financial, legal, PR, etc.) may be minimal or significant. An IRIS of 5 would signify the highest amount of risk. An IRIS of 1 would constitute minimal risk. Along the y-axis 303 is a control score (CS) that ranks the sufficiency of the control set up to address the compliance issue. For instance, a ranking of 1 would indicate that the control is relatively weak and a ranking of 5 would indicate that the control is relatively strong. Each control score is assigned a percentage (CSP). For example, ranking 1 is given a CSP of 10%. Ranking 2 is given a CSP of 20%. Ranking 3 is given a CSP of 30%. Ranking 4 is given a CSP of 40% and ranking 5 is given a CSP of 50%.

Monitoring engine 218 in one example calculates a residual risk score (RRS) 305. The RRS in one example is calculated as follows:

RRS=IRIS−(CSP*RIS)

Upon defining the RRS, a particular compliance issue can be categorized as low, medium, or high risk. For instance, in the example shown, a RRS of 0-1.3 is labeled as “green”. A RRS of 1.4-2.5 is labeled as “yellow”. A RRS of 2.6-5 is labeled “red”. Monitoring engine 218, or alternatively, users 108 may choose to monitor compliance issues differently depending on the category they fall within. For instance, risks in the red category may receive frequent monitoring (e.g. every year) whereas risks in the green category may receive less frequent monitoring (e.g. every 3 years).

It should be noted that the preceding values are provided for exemplary purposes only and may be adjusted according to the needs of the entity to whom they are relevant. It should also be noted that the IRIS, CS, CSP, and RIS values may be calculated by system 100 or entered manually by users 108.

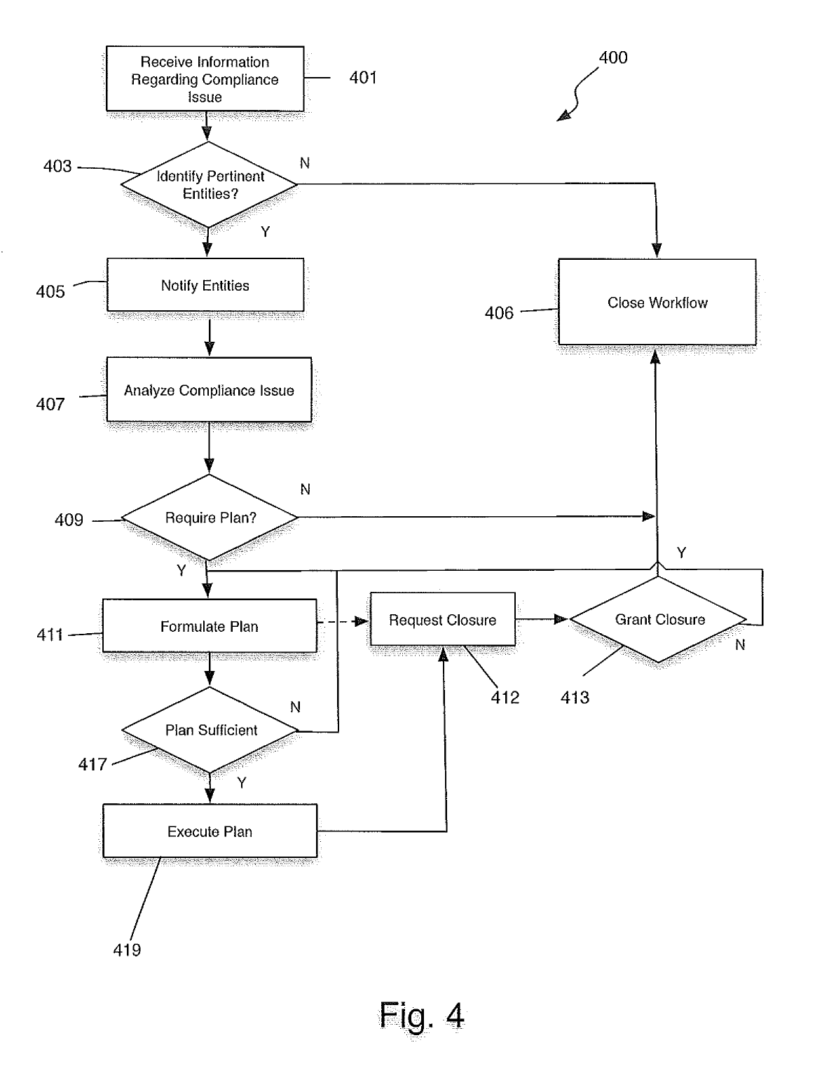

Referring to FIG. 4, an exemplary operation of a process 400 for addressing a compliance issue will now be described for illustrative purposes.

In step 401, information regarding at least one compliance issue is received by identification engine 208 of compliance device 102 and a workflow is created. The information may be input by user 102 or received from rules tracking service provider 106 over network. In step 403, the information is utilized by users 108 and/or triage engine 210 to determine whether the compliance issue is pertinent to one or more entities. If the information is pertinent to one or more entities, the one or more entities are notified in step 405. Otherwise, the workflow is closed. If the one or more entities are notified in response to a determination that the compliance issue is pertinent, then in step 407, analysis engine 212 and/or user(s) representing the one or more entities analyze the compliance issue. In step 409, a determination is made as to whether a compliance plan is warranted. If it is warranted then, in step 411 the users 108 and/or analysis engine 212 formulate a plan, which may include controls, as to how to address the compliance issue. If the users 108 and/or analysis engine 212 determine that a plan is not warranted, then a request for closure of the workflow occurs in box 412. In step 413, management engine 216 and/or user(s) 108 determine whether or not to close the workflow. If the answer is yes, then the workflow is closed. Otherwise, flow returns to step 411 for formulation of a plan. In step 417, management engine 216 and/or user(s) 108 determine whether or not the plan is sufficient to address the compliance issue. If the answer is yes, then flow passes to step 419 in which execution engine 214 and user(s) 108 representing the affected one or more entities execute the plan and log progress. The execution engine 214 and/or user(s) request closure of the workflow in box 412. In box 413, management engine 216 and/or users 108 determine whether or not close the workflow or request that further planning and/or execution occurs. It should be noted, that at any point in process 400, management engine 216 and/or users 108 may request monitoring of a compliance issue. If such a request occurs, then monitoring will occur even if the relevant workflow is closed.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

Although the systems and methods of the subject invention have been described with respect to the embodiments disclosed above, those skilled in the art will readily appreciate that changes and modifications may be made thereto without departing from the spirit and scope of the subject invention.

What is claimed is:

1. A method performed by a computing device and having one or more processors and memory storing one or more programs for execution by the one or more processors, comprising:
receiving information including a representation of at least one compliance issue;
analyzing the information to determine at least one entity to which the at least one compliance issue is pertinent;
forwarding the information to the at least one entity in response to a determination that the legal change is pertinent to the at least one entity;
receiving from the at least one entity a response including a representation as to how the at least one entity intends to address the compliance issue.

2. The method of claim 1, wherein the compliance issue comprises at least one of a change to an existing law or regulation, a new law or regulation, a proposed new law or regulation, and a proposed change to an existing law or regulation.

3. The method of claim 1, wherein the step of analyzing further comprises:
identifying content within the information that indicates that the compliance issue is relevant to the at least one entity.

4. The method of claim 3, wherein the step of identifying comprises:
identifying at least one character within the information that is indicative that the compliance issue is relevant to the at least one entity.

5. The method of claim 4, wherein the step of identifying comprises:
detecting a predetermined flag that indicates that the compliance issue is relevant to the at least one entity.

6. The method of claim 3, wherein the step of identifying comprises:
identifying at least one term or phrase within the information; and
determining from the at least one term or phrase that the compliance issue is relevant to the at least one entity.

7. The method of claim 1, wherein the step of receiving comprises:
receiving a plan from the at least one entity that describes how the at least one entity will address the compliance issue.

8. The method of claim 1, wherein the step of receiving comprises:
receiving a notification from the at least one entity that the at least one entity is sufficiently addressing the compliance issue.

9. The method of claim 1, further comprising:
receiving a notification that the at least one entity has instituted at least one control to address the compliance issue.

10. The method of claim 9, further comprising:
indicating that the at least one entity is in compliance with a legal change in response to receiving the notification.

11. The method of claim 10, further comprising:
monitoring the at least one entity to determine a degree to which the at least one entity is in compliance witth the legal change.

12. The method as recited in claim 11 wherein the step of monitoring comprises:
performing a compliance risk assessment analysis on the at least one control to determine a compliance risk assessment value.

13. The method as recited in claim 12 wherein the step of performing comprises:
evaluating the at least one control to determine a relative strength value of the at least one control.

14. A method as recited in claim 13 wherein the step of performing comprises:
identifying an impact value associated with non-compliance with the legal change.

15. The method of claim 14, wherein the compliance risk assessment value is determined by:
multiplying the relative strength value times the impact value to determine a product; and
subtracting the product from the impact value.

16. The method as recited in claim 15 further comprising:
categorizing the risk assessment value as low, medium, or high.

17. The method as recited in claim 16 further comprising:
monitoring the at least one entity for compliance with the legal change more frequently if the risk assessment value is high than if the risk assessment value is low.
